(19) United States
(12) Patent Application Publication
(10) Pub. No.: US 2004/0258904 A1
(43) Pub. Date: Dec. 23, 2004

(54) Moisture permeable hot melt adhesive sheet and tape

(76) Inventor: Masanori Uemoto, Kyoto (JP)

Correspondence Address: JORDAN AND HAMBURG LLP, 122 EAST 42ND STREET, SUITE 4000, NEW YORK, NY, 10168, US

(21) Appl. No.: 10/870,206

(22) Filed: Jun. 17, 2004

(30) Foreign Application Priority Data
Jun. 20, 2003 (JP) 2003-177365

(51) Int. Cl. B32B 7/12; B32B 9/00; D03D 15/00

(52) U.S. Cl. 428/318.4; 428/343; 428/346; 428/349

(57) ABSTRACT

The invention provides a moisture permeable hot melt adhesive sheet or tape capable of sealing a seam of a water-proof treated cloth while maintaining moisture permeability of the seam of a moisture permeable water-proof cloth. A substrate of a resin film having moisture permeability and water resistance is laminated with a resin film having moisture permeability and hot melt adhesive property to provide a water pressure resistance of 2,000 mm water head or larger by a static water pressure method in JIS 1092, a seam sealing property without water leakage under a pressurization with a water pressure of 2,000 mm water head for 1 minute, and a moisture permeability of 2,000 g/m²·24 H or higher in a method A-1 defined in JIS 1099.

### FIELD OF THE INVENTION

The present invention relates to a sheet capable of hot melt adhesion, to be employed for sealing a seam of a moisture permeable water-proof treated cloth, and a tape formed by slitting such sheet.

### BACKGROUND OF THE INVENTION

The seam of a water-proof treated cloth has been sealed with a sealing liquid employed in the past, and with a sheet or a tape formed by coating a water-proof treated cloth with a tacky adhesive material. The water-proof treated cloth has recently been replaced by a moisture permeable water-proof treated cloth, and for sealing the seam thereof, there is being employed a sheet or a tape formed by laminating a hot melt resin on a water-proof treated cloth or a water-proof resin film.

However, the hot melt adhesive sheet employed in the moisture permeable water-proof treated cloth or the tape formed by slitting such sheet has no moisture permeable property, and, though being improved in a melting point, flowability and an adhesion to the object cloth etc. of the hot melt adhesive, thereby providing an improved seam sealing property, is basically same as the prior seal for the seam of the water-proof treated cloth in the lack of the moisture permeability. On the other hand, JP-A Nos. 60-2775 and 61-47867 disclose, for sealing a sewed seam part, adhesion of a porous polytetrafluoroethylene film, having moisture permeability and water resistance, with an adhesive material, but does not describe a sealing tape with moisture permeability utilizing an adhesive material or the like having moisture permeability.

The present invention has been made in consideration of the foregoing, and is to provide a sheet capable of hot melt adhesion having moisture permeability and a tape formed by slitting such sheet, capable of further improving comfortableness of a rainwear, a skiwear, a mountainwear etc. formed by a moisture permeable water-proof treated cloth and having a moisture permeability, without deteriorating the moisture permeability of a sealed portion of the seam of such moisture permeable water-proof clothing.

### SUMMARY OF THE INVENTION

An adhesive sheet of the present invention is an adhesive sheet adapted for use in sealing a seam of a water-proof treated cloth, formed by laminating a resin film having a moisture permeability and a hot melt adhesive property on a substrate formed by a resin film having a moisture permeability and a water resistance, and provided with a water pressure resistance of 2,000 mm water head or higher in a static water pressure method defined in JIS 1092, a seam sealing property of no water leakage under a pressurization for 1 minute with a water resistance pressure of 2,000 mm water head, and a moisture permeability of 2,000 g/m²·24 H according to a method A-1 defined in JIS 1099.

With respect to the foregoing, the resin film having the moisture permeability and the hot melt adhesion property preferably has a moisture permeability of 3,500 g/m²·24 H or higher according to a method A-1 defined in JIS 1099 at a thickness of 12 μm. Also the resin film preferably has a thickness of 10 to 70 μm. The resin film may be constituted of a polyurethane resin of polyether type, and may further contain, if necessary, a crosslinking agent principally constituted of a heat dissociable block isocyanate in an amount of 5 to 30 wt. % with respect to the solid content of the resin having the hot melt adhesive property.

On the other hand, as the resin film having the moisture permeability and the water resistance and constituting the substrate, there may be employed a porous film constituted for example of polyurethane resin. It is also possible to employ a laminate of such porous film with a non-porous film having moisture permeability.

The moisture permeable hot melt adhesive tape of the invention can be obtained by slitting the aforementioned adhesive sheet of the invention.

### DESCRIPTION OF THE PREFERRED EMBODIMENTS

The hot melt adhesive sheet having moisture permeability of the invention and the tape formed by slitting such sheet is obtained, as explained above, by employing a resin film having a moisture permeability and a water resistance as a substrate, and laminating thereon a resin film having a hot melt adhesive property.

More specifically, in the invention, a two-layered structure employing a resin film having a moisture permeability as a film supporting a water pressure resistance and an adhesive resin film having a hot melt adhesive property and a moisture permeability allows to obtain an adhesive sheet and an adhesive tape, in which the water resistance (sealing property) and the moisture permeability are well balanced.

The resin film constituting the substrate and having the moisture permeability and the water resistance is not particularly restricted, but, in consideration of heat resistance, flexibility, texture, stretchability etc. required for the seam sealing of the moisture permeable water-proof treated cloth, there can be advantageously employed a porous film constituted of polyurethane resin. Particularly in consideration of heat resistance, a film with a softening point of 170° C. or higher is preferable. Examples of the porous film constituted of polyurethane resin include a porous film obtained by a W/O type dry working method and a porous film obtained by a wet working method of dissolving in N,N-dimethylformamide followed by wet coagulation in water. In addition to the porous film of polyurethane resin, there can also be employed, for example, a porous film of polytetrafluoroethylene resin etc.

The aforementioned porous film preferably has a water pressure resistance of 2,000 mm water head or larger (by a static water pressure method according to JIS 1029, hereinafter same unless specified otherwise), and a moisture permeability of 4, 000 g/m²·24 H or larger (by method A-1 or B-1 according to JIS 1099). The thickness of the porous film is not restricted much by the moisture permeability, since the porous film lacks, unlike a non-porous film having moisture permeability, a linear proportional relationship between the moisture permeability and the film thickness. However, in order to achieve a seam sealing ability, a desirable film thickness is in the order of 20 to 100 μm, though a strict range is difficult to define as there are involved multiple factors such as a pore size, a size distribution, a pore rate, a foaming magnification etc. of the porous film. Nevertheless, the film thickness is not particularly restricted as long as the desired seam sealing ability is attained.

Then the resin having the hot melt adhesive property can be employed without restriction as long as necessary moisture permeability is provided. The moisture permeability of the resin is preferably 3,500 g/m²·24 H or higher (according to method A-1 or B-1 in JIS 1099) at a thickness of 12 μm.

Examples of the aforementioned resin having the hot melt adhesive property include a polyurethane resin, a polyester resin, a polyether resin and a polyamide resin, however, since the moisture permeable water-proof treated cloth is often constituted of polyurethane resin, a polyurethane resin is preferred in consideration of adhesive property, flexibility, texture, stretchability etc.

The polyurethane resin can be provided with a moisture permeability by providing a hard segment (part formed by a polyisocyanate) of the polyurethane resin and/or a soft segment (part formed by a polyol) thereof with moisture permeability. In order to provide the hard segment with the moisture permeability, it is conceivable to employ an aliphatic polyisocyanate. However, in consideration of mechanical properties, the moisture permeability is preferably realized by employing a polyether containing polyoxyethylene glycol in the soft segment. Therefore, as the polyurethane resin to be employed in the invention, a polyether-type polyurethane resin mentioned above is particularly preferable.

The polyurethane resin may have a softening temperature within a range of about 80 to 160° C. same as a prior hot melt adhesive resin employed in the seam sealing, however, a polymerization degree of a certain level is required in order to meet the requirement of durability (mechanical characteristics) of the seam sealing, and a resin meeting such requirement often has a softening temperature of 120 to 160° C. However, the softening temperature is not restricted as long as the desired mechanical characteristics are attained.

As the polyurethane resin having the moisture permeability and the hot melt adhesive property, there can also be advantageously employed a copolymer or a mixture of a polyurethane resin excellent in the moisture permeability and a polyurethane resin excellent in the hot melt adhesive property. In such case, the polyurethane resin excellent in the moisture permeability has to be designed with a low softening temperature in order to exploit the hot melt adhesive property of the polyurethane resin with excellent hot melt adhesive property, however it is preferred to design the resin with a high molecular weight in order not to deteriorate the mechanical characteristics even at a low softening temperature.

In order to further improve the hot melt adhesive property to various polyurethane resins employed in the moisture permeable water-proof treated cloth, it is also possible to include a crosslinking agent principally constituted of a heat dissociable block isocyanate in an amount of 5 to 30 wt. % with respect to the solid content of the hot melt adhesive resin constituted of a polyurethane resin composition. In this case, there may be further added a catalyst etc. for controlling the heat dissociable property.

The aforementioned resin film having the hot melt adhesive property preferably has a film thickness of 10 to 70 μm for balancing the sealing property and the moisture permeability.

In case of requiring a higher water pressure resistance (prevention of water leakage under a higher water pressure) for the seam sealing property, the substrate sheet constituted of the aforementioned porous film having the moisture permeability and the water resistance may be laminated with a non-porous film having moisture permeability to constitute a two-layered structure. The non-porous film having moisture permeability is preferably constituted of a resin formed by polyurethane, and, in order to secure the moisture permeability of the substrate of two-layered structure, the thickness of the non-porous film having moisture permeability has to be within a range of 1 to 10 μm, preferably 2 to 5 μm.

The sheet of the invention and the tape formed by slitting such sheet can be obtained by laminating a resin film, having the moisture permeability and the hot melt adhesive property, utilizing the hot melt adhesive property thereof, to a resin film having the moisture permeability and the water resistance by thermal fusion. A specific method is not particularly restricted, but following methods can be cited as examples.

A resin film having the moisture permeability and the water resistance can be produced by a known method. For example, a polyurethane resin film can be obtained by coating an N,N-dimethylformamide solution of a polyurethane resin on a polyester fabric, subjected to a releasing process by a water repellent/calendering process, then wet coagulating the coating in water, and peeling the porous film, formed by rinsing, dehydrating and drying, from the polyester fabric subjected to the aforementioned releasing process. In the N,N-dimethylformamide of polyurethane resin, there may be added an additive such as a fluorinated water-repellent agent in order to improve the moisture permeability and the water resistance.

Also, in order to obtain a two-layered structure of the porous film and the non-porous film having moisture permeability, a solution of a polyurethane resin having moisture permeability may be coated with a known working method such as a floating knife coating method, before the porous film formed by the aforementioned wet coagulation method is peeled off from the polyester fabric subjected to a releasing process. Thus a substrate sheet of a two-layered structure can be obtained by peeling off the film of two-layered structure constituted of the porous film and a non-porous film having moisture permeability, from the polyester fabric subjected to a releasing process.

Then, the resin film having the moisture permeability and the hot melt adhesive property can be obtained by coating, on a releasing paper, a solution obtained by dissolving a hot melt resin in a solvent or a solution obtained by solution polymerization, followed by drying. The hot melt resin film can also be obtained by forming a sheet on a releasing paper by a known technology such as a coating by a melter or by an extrusion.

In case of adding a crosslinking agent principally constituted of a heat dissociable block isocyanate to the resin of hot melt adhesive property, it is preferably added to a solution obtained by dissolving a hot melt resin in a solvent or a solution obtained by solution polymerization, and it can be added within a range of 5 to 30 wt. %, preferably 10 to 20 wt. %, with respect to the solid content of the resin having the hot melt adhesive property.

A sheet formed by laminating the substrate and the hot melt resin film can be used as a sheet by peeling off from the releasing paper, or can also be formed as a tape by slitting such sheet in a desired width by a slitter. The slitting width is not particularly restricted, but it is usually about 15 to 22 mm.

A seam sealing ability for a moisture permeable water-proof treated cloth is evaluated, in a standard method, by heat press sealing a seam of the moisture permeable water-proof treated cloth with a tape slit in a width of 20 mm by a hot air taping machine or a hot press machine, and by confirming the absence of water leakage under a water pressure of 2,000 mm water head for 1 minute in a water pressure resistance tester.

The seam sealing sheet of the invention for the moisture permeable water-proof cloth and the tape formed by slitting the sheet, obtained as explained above, has a seam sealing ability for the moisture permeable water-proof cloth of absence of water leakage under a water pressure of 2, 000 mm water head for 1 minute.

In a recent trend, a printing is applied to the resin film of the moisture permeable water-proof treated cloth in order to provide a characteristic design. In the sheet and the tape of the invention, for responding to such trend, a pattern may be provided on a surface of the substrate opposite to the surface on which the resin film of hot melt adhesive property is laminated. Such pattern may be similar to that on the moisture permeable water-proof treated cloth or may be a completely different pattern or a logo mark in order to provide a characteristic design.

A pattern can be provided on the substrate, in a state where the resin film, having the moisture permeability and the water resistance, is thermally fused with the resin film having the hot melt adhesive property and is thus laminated on the releasing paper, by printing on the upper resin film by a known technology such as gravure printing or screen printing, and peeling off the laminate sheet from the releasing paper. A tape can be obtained by slitting the sheet into a desired width by a slitter.

Also in case of a porous film formed by wet coagulation method on the polyester fabric subjected to the releasing treatment, it is also possible to print on such porous film by a known technology such as gravure printing or screen printing to obtain a sheet of a porous film bearing a designed pattern in advance, and to peel such sheet from the polyester fabric subjected to the releasing process.

The moisture permeable adhesive sheet of the invention and the tape formed by slitting such sheet, owing to a laminate structure of the resin film having the moisture permeability and the water resistance as the substrate material and the resin film having the moisture permeability and the hot melt adhesive property, can be adhered for example by hot air and can seal a seam of a moisture permeable water-proof treated cloth while maintaining the moisture permeability thereof, thus being capable of improving the comfortableness of a clothing having a moisture permeable water-proof property, such as a rainwear, a skiwear or a mountainwear. In particular, the moisture permeable hot melt adhesive sheet and tape of the invention are highly useful in a wear of a design much utilizing the sealing tape or a wear utilizing the hot melt adhesive sheet also in a non-seam portion.

In the following, the present invention will be clarified further by examples and comparative examples, but the invention is not limited by such examples.

### EXAMPLE 1

A coating liquid was prepared by mixing 100 parts by weight of Chrisbon 8166 (polyurethane resin solution, softening temperature: 195° C., manufactured by Dai-Nippon Ink and Chemicals Inc.), 1 part by weight of FC-1208 (fluorinated water-repellent agent, manufactured by Sumitomo-3M Co.), 1 part by weight of Lucentite STN (clay-organic complex, manufactured by Co-Op Chemical Co.), 5 parts by weight of Lyoace M-118 White (pigment, manufactured by Toyo Ink Mfg. Co.) and 40 parts by weight of N,N-dimethylformamide. A polyester plain weave fabric, formed by yarns of 84 decitex both in the warp and the woof, after refining and setting steps, was subjected to a padding process with a water-repellent liquid formed by 5 wt. % of Unidyne TG-411 (fluorinated water-repellent agent, manufactured by Daikin Industries Ltd.) and 95 wt. % of water and with a squeeze rate of about 50%, then dried at about 120° C. and subjected to a calendering on a surface twice at 190° C. On the calendered surface of thus obtained releasing fabric, the aforementioned coating liquid was coated by a knife-over-roll method with a clearance of 0.2 mm. The coated fabric was immersed in a 10 wt. % aqueous solution of N,N-dimethylformamide for wet coagulation to obtain a porous film, then rinsed with warm water in such a manner that N,N-dimethylformamide scarcely remained, and dried at about 120° C. to obtain, on the releasing fabric, a porous film having moisture permeability and water resistance. The porous film had a thickness of 40 μm, a water pressure resistance of 3,000 mm water head (measured without peeling from the releasing fabric), and a moisture permeability of 7,000 g/m²·24 H (according to A-1 method, JIS 1099).

Then a coating liquid, constituted of 100 parts by weight of Heimlene Y-611-63 (solution of polyether-type polyurethane having moisture permeability and hot melt adhesive property, moisture permeability of 7,000 g/m²·24 H (according to A-1 method, JIS 1099) at a thickness of 12 m, softening temperature: 143° C., manufactured by Dainichiseika Color & Chemicals Mfg. Co.) and 40 parts by weight of N,N-dimethylformamide was coated and dried on a releasing paper so as to obtain a film thickness of 40 μm after drying, thereby obtaining a resin film having moisture permeability and hot melt adhesive property on the releasing paper. The film had a moisture permeability of 4,100 g/m²·24 H (according to A-1 method, JIS 1099).

A sheet, obtained by peeling the aforementioned porous film having moisture permeability and water resistance from the releasing fabric, was laminated, by heat pressing at 120° C., with the resin film having moisture permeability and hot melt adhesive property of a thickness of 40 μm on the releasing paper, thereby obtaining a sheet having moisture permeability, capable of hot melt adhesion and having a seam sealing ability for a moisture permeable water-proof treated cloth. The sheet had a thickness of 75 μm, a water pressure resistance of 3,000 mm water head (measured together with the releasing fabric), and a moisture permeability of 3, 500 g/m²·24 H (according to A-1 method, JIS 1099).

A tape was prepared by slitting the sheet into a width of 20 mm, and was used to seal a seam of a moisture permeable water-proof treated cloth A (coated with polyurethane by wet coagulation method; moisture permeability of 8,000 g/m²·24 H (according to A-1 method, JIS 1099)) by hot air, utilizing a hot-air taping machine (QHP-778L, manufactured by Queen Light Electronic Industries, Ltd., nozzle temperature: 450° C., nozzle air pressure: 40 kPa, roller temperature: no heating/room temperature, roller pressure: 290 kPa, speed: 3 m/min). Water leakage was measured by pressurizing a sealed part, in a water pressure resistance tester (static water pressure method according to JIS 1092) with a pressure of 2,000 mm water head and holding the pressure for 1 minute, and the absence of water leakage was confirmed. Also a moisture permeability, measured after heat pressing the sheet, at 150° C., over the entire surface of the moisture permeable water-proof treated cloth A, was 3,200 g/m²·24 H (according to A-1 method, JIS 1099).

### EXAMPLE 2

On the surface of the porous film having moisture permeability and water resistance, obtained on the releasing fabric of Example 1, a solution constituted of 100 parts by weight of Heimlene Y-237 (solution of polyurethane having moisture permeability, moisture permeability of 5,200 g/m 224 H (according to A-1 method, JIS 1099) at a thickness of 12 μm, softening temperature: 175° C., manufactured by Dainichiseika Color & Chemicals Mfg. Co.) and 50 parts by weight of methyl ethyl ketone was coated by a floating knife method utilizing a doctor blade with a rounded edge of 2 mmφ, thereby obtaining a two-layered substrate sheet, having a thickness of 42 μm, a water pressure resistance of 150 kPa (measured without peeling from the releasing fabric) and a moisture permeability of 5,500 g/m²·24 H (according to A-1 method, JIS 1099) (measured after peeling from the releasing fabric) and constituted of a porous film having moisture permeability and water resistance and a non-porous film having moisture permeability.

Then the aforementioned two-layered substrate sheet was peeled off from the releasing fabric and was laminated, by heat pressing at 120° C., with the same resin film as in Example 1, having moisture permeability and hot melt adhesive property, of a thickness of 40 μm on the releasing paper, thereby obtaining a sheet having moisture permeability, capable of hot melt adhesion and having a seam sealing ability for a moisture permeable water-proof treated cloth. The sheet had a thickness of 77 μm, a water pressure resistance of 150 kPa (according to high water pressure resistance method, JIS 1092) (measured together with the releasing fabric), and a moisture permeability of 3, 000 g/m²·24 H in A-1 method, JIS 1099 and 4,000 g/m²·24 H in B-1 method, JIS 1099.

As in Example 1, a tape was prepared by slitting the sheet into a width of 20 mm, and was used, with a hot-air taping machine used in Example 1 and under same conditions as in Example 1, to seal with hot air a seam of the moisture permeable water-proof treated cloth A and a seam of a moisture permeable water-proof treated cloth B (laminated with a moisture permeable hydrophilic non-porous polyurethane film; moisture permeability of 12,000 g/m²·24 H (according to B-1 method, JIS 1099). In each, water leakage was measured by pressurizing a sealed part, in a water pressure resistance tester (high water pressure resistance method according to JIS 1092) with a pressure of 100 kPa and holding the pressure for 3 minutes, and the absence of water leakage was confirmed in both the moisture permeable water-proof treated cloths A and B. Also the moisture permeable water-proof treated cloth A on which the sheet was heat pressed, at 150° C., over the entire surface had a moisture permeability of 2,800 g/m²·24 H (according to A-1 method, JIS 1099), and the moisture permeable water-proof treated cloth B on which the sheet was heat pressed, at 150° C., over the entire surface had a moisture permeability of 4,000 g/m²·24 H (according to B-1 method, JIS 1099).

### EXAMPLE 3

A coating liquid, constituted of 100 parts by weight of Heimlene Y-611-63 employed in Example 1, 8 parts by weight of Coronate 2513 (non-yellowing block polyisocyanate, manufactured by Nippon Polyurethane Industry Co.), 1 part by weight of Accel T (crosslinking catalyst, manufactured by Dai-Nippon Ink & Chemicals, Inc.) and 40 parts by weight of N,N-dimethylformamide was coated and dried on a releasing paper so as to obtain a film thickness of 40 μm after drying, thereby obtaining a resin film having moisture permeability and hot melt adhesive property on the releasing paper. The film had a moisture permeability of 4,000 g/m²·24 H (according to A-1 method, JIS 1099).

Then a two-layered substrate sheet same as in Example 2, constituted of a porous film having moisture permeability and water resistance and a non-porous film having moisture permeability, was peeled off from the releasing fabric and was laminated, by heat pressing at 120° C., with the aforementioned resin film of a thickness of 40 μm, having moisture permeability and hot melt adhesive property, including a heat dissociable block isocyanate and a crosslinking catalyst and formed on the releasing paper, thereby obtaining a sheet having moisture permeability, capable of hot melt adhesion and having a seam sealing ability for a moisture permeable water-proof treated cloth. The sheet had a thickness of 77 μm, a water pressure resistance of 150 kPa (according to high water pressure resistance method, JIS 1092) (measured together with the releasing fabric), and a moisture permeability of 2,900 g/m²·24 H in A-1 method, JIS 1099 and 3,800 g/m²·24H in B-1 method, JIS 1099.

As in Example 1, a tape was prepared by slitting the sheet into a width of 20 mm, and was used, with a hot-air taping machine used in Example 1 and under same conditions as in Example 1 except for employing a nozzle temperature of 550° C., to seal with hot air a seam of the aforementioned moisture permeable water-proof treated cloths A and B. Each cloth was subjected to a washing according to JIS L-0217 (method 103) ten times, then air dried and subjected to an observation of an adhesion state of the tape. Lifting or peeling of the tape was not observed in both moisture permeable water-proof treated cloths A and B. Also in each sample after washing ten times, water leakage was measured by pressurizing the the sealed part of the sample, in a water pressure resistance tester (static water pressure method according to JIS 1092) with a pressure of 2,000 mm water head and holding the pressure for 1 minute, and the absence of water leakage was confirmed in both moisture permeable water-proof treated cloths A and B.

Also the moisture permeable water-proof treated cloth A on which the sheet was heat pressed, at 150° C., over the entire surface had a moisture permeability of 2,700 g/m²·24 H (according to A-1 method, JIS 1099), and the moisture permeable water-proof treated cloth B on which the sheet was heat pressed, at 150° C., over the entire surface had a moisture permeability of 3,800 g/m²·24 H (according to B-1 method, JIS 1099).

### COMPARATIVE EXAMPLE 1

On a porous film having moisture permeability and water resistance, same as in Example 1 and without being peeled off from the releasing fabric, there was laminated a sheet of Pandex T-5102S (polyurethane resin (polyester-type polyurethane) pellet for adhesive, moisture permeability: 500 g/m²·24 H in a sheet of 50 μm thick, softening temperature: 70-85° C., manufactured by Dai-Nippon Ink and Chemicals Inc.) extruded from a T-die extruder regulated at a thickness of 50 μm. The obtained sheet had a thickness of 90 μm, a water pressure resistance of 3,000 mm water head (according to static water pressure method, JIS 1092)(measured together with the releasing fabric), and a moisture permeability of 500 g/m²·24 H in A-1 method, JIS 1099 and 500 g/m²·24H in B-1 method, JIS 1099.

As in Example 1, a tape was prepared by slitting the sheet into a width of 20 mm, and was used, with a hot-air taping machine used in Example 1 and under same conditions as in Example 1, to seal with hot air a seam of the moisture permeable water-proof treated cloths A and B. In each, water leakage was measured by pressurizing a sealed part, in a water pressure resistance tester (static water pressure method according to JIS 1092) with a pressure of 2,000 mm water head and holding the pressure for 1 minute, and the absence of water leakage was confirmed in both moisture permeable water-proof treated cloths A and B. Also the moisture permeable water-proof treated cloth A on which the sheet was heat pressed, at 150° C., over the entire surface had a moisture permeability of 400 g/m²·24 H (according to A-1 method, JIS 1099), and the moisture permeable water-proof treated cloth B on which the sheet was heat pressed, at 150° C., over the entire surface had a moisture permeability of 500 g/m²·24 H (according to B-1 method, JIS 1099).

### COMPARATIVE EXAMPLE 2

A coating liquid constituted of 100 parts by weight of Chrisbon 8566 (polyurethane resin solution, softening temperature: 230° C., manufactured by Dai-Nippon Ink and Chemicals Inc.), 5 parts by weight of Dailac TD-2100 White (pigment, manufactured by Dai-Nippon Ink and Chemicals Inc.), 10 parts by weight of N, N-dimethylformamide and 30 parts by weight of methyl ethyl ketone, was coated on a releasing paper by a knife-over-roll method with a clearance of 0.16 mm, and dried at about 120° C. to obtain a non-porous film on the releasing paper. The non-porous film had a thickness of 30 μm, a water pressure resistance of 150 kPa (high water pressure method, JIS 1092)(measured together with a releasing fabric), and a moisture permeability of 500 g/m²·24 H (according to A-1 method, JIS 1099).

Then a sheet of Pandex T-5102S, employed in Comparative Example 1, was extruded from a T-die extruder regulated at a thickness of 50 μm and laminated with the non-porous film on the releasing paper.

The obtained sheet had a thickness of 80 μm, a water pressure resistance of 150 kPa (high water pressure method, JIS 1092)(measured together with the releasing fabric), and a moisture permeability of 300 g/m²·24 H in A-1 method, JIS 1099.

As in Example 1, a tape was prepared by slitting the sheet into a width of 20 mm, and was used, with a hot-air taping machine used in Example 1 and under same conditions as in Example 1, to seal with hot air a seam of the moisture permeable water-proof treated cloth A. Water leakage was measured by pressurizing a sealed part, in a water pressure resistance tester (static water pressure method according to JIS 1092) with a pressure of 2,000 mm water head and holding the pressure for 1 minute, and the absence of water leakage was confirmed. Also the moisture permeable water-proof treated cloth A on which the sheet was heat pressed, at 150° C., over the entire surface had a moisture permeability of 300 g/m²·24 H (according to A-1 method, JIS 1099).

### COMPARATIVE EXAMPLE 3

A coating liquid constituted of 100 parts by weight of Heimlene Y-257 (solution of polyurethane having moisture permeability, moisture permeability of 4,300 g/m²·24 H (according to A-1 method, JIS 1099) at a thickness of 12 μm, softening temperature: 190° C., manufactured by Dainichiseika Color & Chemicals Mfg. Co.), 5 parts by weight of Seikaseven BS-7093 White (pigment, manufactured by Dainichiseika Color & Chemicals Mfg. Co.), 10 parts by weight of N,N-dimethylformamide and 30 parts by weight of methyl ethyl ketone, was coated on a releasing paper by a knife-over-roll method with a clearance of 0.16 mm, and dried at about 120° C. to obtain a non-porous film on the releasing paper. The non-porous film had a thickness of 30 μm, a water pressure resistance of 150 kPa (high water pressure method, JIS 1092) (measured together with a releasing fabric), and a moisture permeability of 2,100 g/m²·24 H (according to A-1 method, JIS 1099).

This non-porous film was laminated by heat pressing at 120° C. with a resin film of a thickness of 40 μm, same as in Example 1, having moisture permeability and hot melt adhesive property and provided on a releasing film, thereby obtaining a sheet having moisture permeability, capable of hot melt adhesion and having a seam sealing ability for a moisture permeable water-proof treated cloth. The obtained sheet had a thickness of 70 μm, a water pressure resistance of 150 kPa (high water pressure method, JIS 1092) (measured together with the releasing fabric), and a moisture permeability of 1,400 g/m²·24H in A-1 method, JIS 1099.

As in Example 1, a tape was prepared by slitting the sheet into a width of 20 mm, and was used, with a hot-air taping machine used in Example 1 and under same conditions as in Example 1, to seal with hot air a seam of the moisture permeable water-proof treated cloth A. Water leakage was measured by pressurizing a sealed part, in a water pressure resistance tester (static water pressure method according to JIS 1092) with a pressure of 2,000 mm water head and holding the pressure for 1 minute, and the absence of water leakage was confirmed. Also the moisture permeable water-proof treated cloth A on which the sheet was heat pressed, at 150° C., over the entire surface had a moisture permeability of 400 g/m²·24 H (according to A-1 method, JIS 1099), and the moisture permeable water-proof treated cloth B on which the sheet was heat pressed, at 150° C., over the entire surface had a moisture permeability of 1,100 g/m²·24 H (according to A-1 method, JIS 1099).

Constructions of the adhesive sheets obtained in the foregoing examples and comparative examples are summarized in Table 1.

TABLE 1

| | | Example 1 | Example 2 | Example 3 | Comp. Ex. 1 | Comp. Ex. 2 | Comp. Ex. 3 |
|---|---|---|---|---|---|---|---|
| Substrate | thickness (μm) | 40 | 42 | 42 | 40 | 30 | 30 |
| | water resistance | 3000 (static) | 150 kPa (high) | 150 kPa (high) | 3000 (static) | 150 kPa (high) | 150 kPa (high) |
| | (mm water head or kP)* | | | | | | |
| | moisture permeability (g/m² · 24 H)** | 7000 (A-1) | 5500 (A-1) | 5500 (A-1) | 7000 (A-1) | 500 (A-1) | 2100 (A-1) |
| Hot melt | thickness (μm) | 40 | 40 | 40 | 50 | 50 | 40 |
| adhesive | moisture permeability (g/m² · 24 H) | 4100 (A-1) | 4100 (A-1) | 4000 (A-1) | 500 (A-1) | 500 (A-1) | 4100 (A-1) |
| resin film | | | | | | | |
| Adhesive | thickness (μm) | 75 | 77 | 77 | 90 | 80 | 70 |
| sheet | water resistance (mm water head)* | 3000 (static) | 150 kPa (high) | 150 kPa (high) | 3000 (static) | 150 kPa (high) | 150 kPa (high) |
| (laminate) | moisture permability (g/m² · 24 H)** | 3500 (A-1) | 3000 (A-1) | 2900 (A-1) | 500 (A-1) | 300 (A-1) | 1400 (A-1) |
| | | — | 4000 (B-1) | 3800 (B-1) | 500 (B-1) | — | — |

*according to static water pressure method or high water pressure resistance method, JIS 1092
**according to A-1 or B-1 method, JIS 1099

1. A moisture permeable hot melt adhesive sheet for use for sealing a seam of a water-proof treated cloth, comprising:
a resin film having moisture permeability and water resistance as a substrate material, and a resin film having moisture permeability and hot melt adhesive property laminated thereon;
wherein said sheet has a water pressure resistance of 2,000 mm water head or larger according to a static water pressure method defined in JIS 1092, a seam sealing property without water leakage under a pressurization with a water pressure of 2,000 mm water head for 1 minute, and a moisture permeability of 2,000 g/m²·24 H or higher according to a method A-1 defined in JIS 1099.

2. A moisture permeable hot melt adhesive sheet according to claim 1, wherein said resin film having moisture permeability and hot melt adhesive property has a moisture permeability of 3,500 g/m²×24 H or higher according to a method A-1 defined in JIS 1099, at a thickness of 12 μm.

3. A moisture permeable hot melt adhesive sheet according to claim 1 or 2, wherein said resin film having moisture permeability and hot melt adhesive property has a thickness from 10 to 70 μm.

4. A moisture permeable hot melt adhesive sheet according claim 1 or 2, wherein said resin film having moisture permeability and hot melt adhesive property is formed by polyether-type polyurethane resin.

5. A moisture permeable hot melt adhesive sheet according to claim 4, wherein said resin film having moisture permeability and hot melt adhesive property includes a crosslinking agent principally constituted by a heat dissociable block isocyanate in an amount of 5 to 30 wt. % with respect to a solid content of the resin having the hot melt adhesive property.

6. A moisture permeable hot melt adhesive sheet according to claim 1 or 2, wherein said substrate material is a porous film comprised of polyurethane resin.

7. A moisture permeable hot melt adhesive sheet according to claim 6, wherein said substrate material is formed by laminating a non-porous film having moisture permeability on said porous film.

8. A moisture permeable hot melt adhesive tape obtained by slitting a moisture permeable hot melt adhesive sheet according to claim 1 or 2.
